(19) United States
(12) Patent Application Publication
(10) Pub. No.: US 2026/0012570 A1
(43) Pub. Date: Jan. 8, 2026

(54) THREE-DIMENSIONAL-IMAGE DISPLAY DEVICE

(71) Applicant: Shanghai AVIC Optoelectronics Co., Ltd., Shanghai (CN)

(72) Inventors: Naoyasu IKEDA, Kawasaki (JP); Tetsushi SATO, Kawasaki (JP)

(73) Assignee: Shanghai AVIC Optoelectronics Co., Ltd., Shanghai (CN)

(21) Appl. No.: 19/256,563

(22) Filed: Jul. 1, 2025

(30) Foreign Application Priority Data
Jul. 5, 2024 (JP) 2024-108758

(51) Int. Cl. H04N 13/398; H04N 13/339

(52) U.S. Cl. CPC H04N 13/398; H04N 13/339

(57) ABSTRACT

A three-dimensional-image display device includes a liquid crystal display panel, a variable focus lens unit, and a controller. The liquid crystal display panel displays a first image and a second image that are sequentially displayed by line progressive scanning, and emits display light of the first image and display light of the second image. The variable focus lens unit switches the focal lengths for the display lights to form, as virtual images, the first image and the second image respectively on a first display surface and a second display surface. The controller configures display periods, during which either the first image or the second image is displayed in each display period, each with a plurality of frame periods, and controls luminance of pixels of the liquid crystal display panel to minimum luminance of the pixels in a last frame period.

This application claims the benefit of Japanese Patent Application No. 2024-108758, filed on Jul. 5, 2024, the entire disclosure of which is incorporated by reference herein.

### FIELD OF THE INVENTION

The present disclosure relates generally to a three-dimensional-image display device.

### BACKGROUND OF THE INVENTION

In the related art, depth fused 3D (DFD) type three-dimensional-image display devices are known as display devices that display three-dimensional images (3D images) viewable by the naked eye. For example, Unexamined Japanese Patent Application Publication No. 2005-129983 describes a three-dimensional display apparatus including a display device that alternately displays two two-dimensional images, a polarizing plate that emits outgoing light emitted from the display device as polarized light, a polarization switching device that switches the polarization direction of the outgoing light emitted from the polarizing plate, and a polarized bifocal lens.

With the three-dimensional display apparatus of Unexamined Japanese Patent Application Publication No. 2005-129983, the two two-dimensional images are alternately formed on respective display surfaces located at different depth positions from the perspective of an observer, and luminance or transmittance of the two two-dimensional images is independently changed. As such the three-dimensional display apparatus displays a three-dimensional image.

When a display device such as a liquid crystal display device, an organic electro luminescence (EL) display device, or the like in which a display operation is continuously performed over a single frame period by line progressive scanning is used for the display device included in the three-dimensional display apparatus of Unexamined Japanese Patent Application Publication No. 2005-129983, luminance of pixels (luminance of pixels forming a two-dimensional image) recognized by the observer is the average of the luminance of pixels of the display device over the single frame period. In this case, the luminance recognized by the observer is substantially equivalent to the luminance of the display device at a pixel located at a start of the line progressive scanning. Conversely, a pixel located at an end of the line progressive scanning has a shorter time to emit display light corresponding to an image signal in the single frame period, and thus, the luminance recognized by the observer is significantly different from the luminance of the display device.

That is, rewriting of pixel signals (pixel data) is performed at different times within the single frame period depending on the position of the display device (two-dimensional image) in a line progressive direction. Therefore, even if the luminance of pixels of the display device is the same, the luminance (the luminance of pixels of the display device averaged in the single frame period) recognized by the observer differs depending on the position of the display device in the line progressive direction. In the display device included in the three-dimensional display apparatus of Unexamined Japanese Patent Application Publication No. 2005-129983, if the pixels, of the display device, having the same luminance are recognized as pixels having different luminance by the observer depending on the position of the display device in the line progressive direction, a three-dimensional image having a shape different from a shape of the three-dimensional image to be displayed is recognized by the observer.

### SUMMARY OF THE INVENTION

A three-dimensional-image display device according to a first aspect of the present disclosure includes:
a liquid crystal display panel to sequentially display a first image and a second image, and emit display light of the first image and display light of the second image;
a variable focus lens unit to switch between a focal length for the display light of the first image and a focal length for the display light of the second image; and
a controller to control display of the liquid crystal display panel, wherein
the first image and the second image are two-dimensional images and are obtained by projecting a display target from an observer side on a corresponding one of a first display surface and a second display surface, the first display surface and the second display surface being positioned at different positions in a depth direction from a perspective of an observer,
the liquid crystal display panel displays each of the first image and the second image by line progressive scanning,
the variable focus lens unit forms, as virtual images, the first image and the second image respectively on the first display surface and the second display surface, and
the controller
   configures display periods, during which either the first image or the second image is displayed in each display period, each with a plurality of frame periods, and
   controls luminance of pixels of the liquid crystal display panel to minimum luminance in a last frame period of the plurality of frame periods included in the display period.

A three-dimensional-image display device according to a second aspect of the present disclosure includes:
a self-luminous display panel to sequentially display a first image and a second image, and emit display light of the first image and display light of the second image;
a variable focus lens unit to switch between a focal length for the display light of the first image and a focal length for the display light of the second image; and
a controller to control display of the self-luminous display panel, wherein
the first image and the second image are two-dimensional images and are obtained by projecting a display target from an observer side on a corresponding one of a first display surface and a second display surface, the first display surface and the second display surface being positioned at different positions in a depth direction from a perspective of an observer,
the self-luminous display panel displays each of the first image and the second image by line progressive scanning,
the variable focus lens unit forms, as virtual images, the first image and the second image respectively on the first display surface and the second display surface, and
the controller
   configures display periods, during which either the first image or the second image is displayed in each display period, each with a plurality of frame periods, and
   controls luminance of pixels of the self-luminous display panel to minimum luminance in a last frame period of the plurality of frame periods included in the display period.

It is to be understood that both the foregoing general description and the following detailed description are exemplary and explanatory and are not restrictive of this disclosure.

### BRIEF DESCRIPTION OF DRAWINGS

FIG. 1 is a schematic diagram illustrating a three-dimensional-image display device according to Embodiment 1;

FIG. 2 is a plan view illustrating a liquid crystal display panel according to Embodiment 1;

FIG. 3 is a cross-sectional view illustrating a polarization switcher according to Embodiment 1;

FIG. 4 is a cross-sectional view illustrating a polarized bifocal lens according to Embodiment 1;

FIG. 5 is a block diagram illustrating a controller according to Embodiment 1;

FIG. 6 is a diagram illustrating a hardware configuration of the controller according to Embodiment 1;

FIG. 7 is a diagram illustrating a first image according to Embodiment 1;

FIG. 8 is a diagram illustrating a second image according to Embodiment 1;

FIG. 9 is a diagram for explaining display control of the liquid crystal display panel and control of the polarization switcher, according to Embodiment 1;

FIG. 10 is a diagram for explaining a display operation of a liquid crystal display panel according to a comparative example;

FIG. 11 is a diagram illustrating a first image recognized, according to the comparative example;

FIG. 12 is a diagram illustrating a second image recognized, according to the comparative example;

FIG. 13 is a diagram for explaining display control of a liquid crystal display panel according to Embodiment 2;

FIG. 14 is a diagram for explaining display control of a liquid crystal display panel according to Embodiment 3;

FIG. 15 is a schematic diagram illustrating a three-dimensional-image display device according to Embodiment 4;

FIG. 16 is a plan view illustrating a self-luminous display panel according to Embodiment 4;

FIG. 17 is a diagram illustrating a relationship between a luminance half-life time and luminance of an organic EL element, according to Embodiment 4;

FIG. 18 is a diagram illustrating a luminance reduction rate according to Embodiment 4;

FIG. 19 is a diagram illustrating a relationship between (i) the luminance of the organic EL element and a time the organic EL element emits light, and (ii) a luminance half-life time of the self-luminous display panel, according to Embodiment 4; and

FIG. 20 is a diagram for explaining display control of a liquid crystal display panel according to a modified example.

### DETAILED DESCRIPTION OF THE INVENTION

Hereinafter, a three-dimensional-image display device according to various embodiments is described with reference to the drawings.

### Embodiment 1

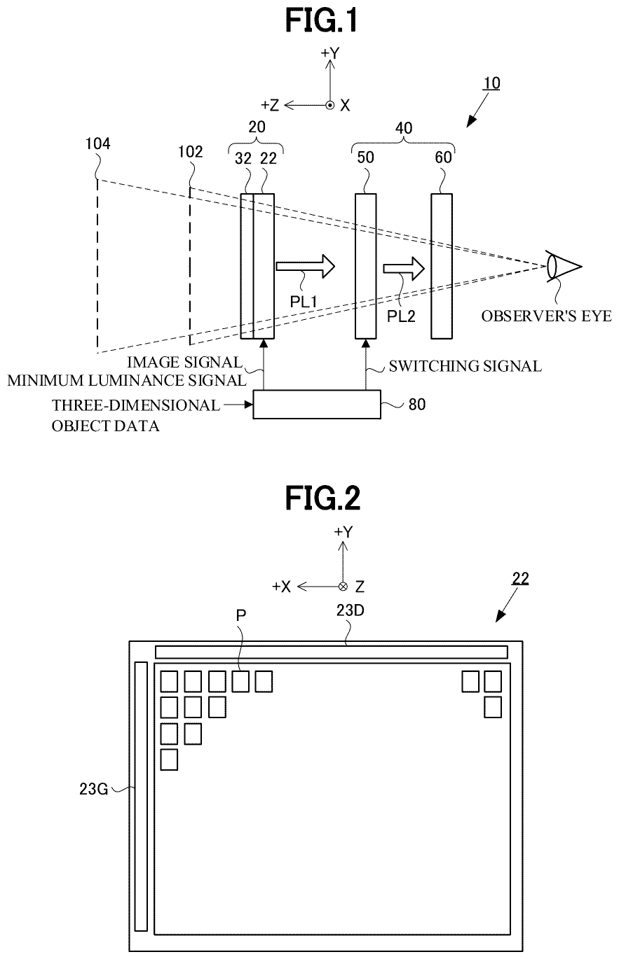

A three-dimensional-image display device 10 according to the present embodiment is described with reference to FIGS. 1 to 12. The three-dimensional-image display device 10 is a display device that displays three-dimensional images by depth fused 3D (DFD). In one example, the three-dimensional-image display device 10 is combined with eyepieces, and is used as a head-mounted display. In the present embodiment, an example of a three-dimensional-image display device 10 that uses a monochrome liquid crystal panel is described.

### Overall Configuration

Firstly, an overall configuration of the three-dimensional-image display device 10 is described. As illustrated in FIG. 1, the three-dimensional-image display device 10 includes a display unit 20, a variable focus lens unit 40, and a controller 80.

The display unit 20 sequentially displays a first image and a second image in time divisions. In the present embodiment, the display unit 20 emits display light PL1 of the first image and display light PL1 of the second image as polarized light. The polarization direction of the polarized light is a predetermined first direction. The variable focus lens unit 40 switches between a focal length for the display light PL1 of the first image and a focal length for the display light PL1 of the second image to form, as virtual images, the first image and the second image respectively on a first display surface 102 and a second display surface 104. The variable focus lens unit 40 includes a polarization switcher 50 and a polarized bifocal lens 60. The polarization switcher 50 emits display light PL2 while switching the polarization direction of the display light PL1 emitted from the display unit 20 between the predetermined first direction and a predetermined second direction. The polarized bifocal lens 60 is a lens for which the focal length, for the outgoing light emitted from the polarization switcher 50, differs depending on the polarization direction of the outgoing light. The controller 80 controls display of the display unit 20. The controller 80 supplies, to the display unit 20, a first image signal for displaying the first image to the display unit 20, a second image signal for displaying the second image to the display unit 20, and minimum luminance signal, which is described later. Furthermore, the controller 80 controls the switching of the polarization direction by the polarization switcher 50.

In the present specification, to facilitate comprehension, in the three-dimensional-image display device 10 of FIG. 1, the left direction (the left direction on paper) is referred to as the “+Z direction”, the up direction (the up direction on paper) is referred to as the “+Y direction”, and the direction perpendicular to the +Y direction and the +Z direction (the front direction on paper) is referred to as the “+X direction”. Additionally, the first image signal for displaying the first image and the second image signal for displaying the second image are collectively referred to as “image signals”.

### Display Unit

The display unit 20 of the three-dimensional-image display device 10 includes a liquid crystal display panel 22 and a light source 32. The liquid crystal display panel 22 of the display unit 20 modulates, based on the first image signal, the second image signal, and the minimum luminance signal supplied from the controller 80, light emitted from the light source 32, thereby sequentially displaying the first image and the second image in time divisions. The liquid crystal display panel 22 emits the display light PL1 of images (for example, the first image and the second image) as polarized light. The polarization direction of the polarized light is a predetermined first direction. The display light PL1 emitted from the liquid crystal display panel 22 enters the polarization switcher 50. In the present embodiment, the predetermined first direction is the X direction.

The first image and the second image are two-dimensional images, and are obtained by projecting, from an observer side, a display target on a corresponding one of the first display surface 102 and the second display surface 104 that are positioned at different positions in a depth direction (the +Z direction) from the perspective of the observer. The first display surface 102 and the second display surface 104 are described later.

In one example, the liquid crystal display panel 22 is implemented as a transmissive twisted nematic (TN) liquid crystal panel that is active matrix driven by line progressive scanning by a thin film transistor (TFT). As illustrated in FIG. 2, the liquid crystal display panel 22 includes pixels P arranged in a matrix, a gate driver 23G, and a data driver 23D. The gate driver 23G sequentially selects the pixels P by row, and performs line progressive scanning in the −Y direction from the +Y side. The data driver 23D supplies, to each of the selected pixels P, a voltage corresponding to an image signal or a minimum luminance signal, thereby writing the image signal or the minimum luminance signal to each of the pixels P. Note that FIG. 2 illustrates only a portion of the pixels P arranged in the matrix. Additionally, the liquid crystal display panel 22 includes a light-transmitting substrate, the TFT, a liquid crystal, a polarizing plate, and the like, which are not illustrated.

The light source 32 of the display unit 20 is a light source of the liquid crystal display panel 22. In one example, the light source 32 is implemented as a direct backlight that is provided on a back surface of the liquid crystal display panel 22. The light source (backlight) 32 includes a light emitting diode (LED), a reflection sheet, a diffusion sheet, and the like, which are not illustrated.

### Variable Focus Lens Unit

The polarization switcher 50 of the three-dimensional-image display device 10 switches, based on a switching signal that is synchronized with the image signals, the polarization direction of the display light PL1 emitted from the display unit 20 between the predetermined first direction (the X direction) and a predetermined second direction. In the present embodiment, the predetermined second direction is the Y direction. Specifically, when the first image is being displayed on the liquid crystal display panel 22 of the display unit 20, the polarization switcher 50 maintains the polarization direction of the incident display light PL1 in the X direction, and emits display light PL2. When the second image is being displayed on the liquid crystal display panel 22 of the display unit 20, the polarization switcher 50 switches the polarization direction of the incident display light PL1 to the Y direction to emit the display light PL2.

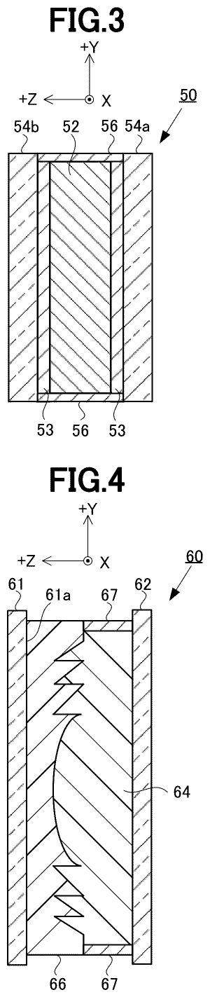

In one example, the polarization switcher 50 is implemented as a TN liquid crystal element that has a twist angle of 90°. As illustrated in FIG. 3, the polarization switcher (the TN liquid crystal element) 50 includes a liquid crystal 52, two light-transmitting substrates 54a and 54b, and a non-illustrated alignment film that aligns the liquid crystal 52. The light-transmitting substrate 54a and the light-transmitting substrate 54b each include an electrode 53 that applies voltage to the liquid crystal 52. The light-transmitting substrate 54a and the light-transmitting substrate 54b are adhered to each other by a sealing material 56, thereby sandwiching the liquid crystal 52. When an OFF level switching signal is supplied, the polarization switcher 50 rotates the polarization direction of the display light PL1 by 90°, and emits the display light PL2. The polarization direction of the display light PL2 is the Y direction. When an ON level switching signal is supplied to the polarization switcher 50, the liquid crystal 52 is aligned perpendicularly to the light-transmitting substrates 54a and 54b, and the polarization switcher 50 maintains the polarization direction of the display light PL1 in the X direction, and emits the display light PL2. The display light PL2 emitted from the polarization switcher 50 enters the polarized bifocal lens 60. The switching signal is described later.

The polarized bifocal lens 60 of the three-dimensional-image display device 10 is a lens for which the focal length, for the display light PL2 emitted from the polarization switcher 50, differs depending on the polarization direction (the X direction and the Y direction) of the display light PL2. The polarized bifocal lens 60 forms the first image and the second image, as virtual images from the perspective of the observer, respectively on the first display surface 102 and the second display surface 104. The first display surface 102 and the second display surface 104 are imaginary display surfaces positioned at different positions in the depth direction (the +Z direction) from the perspective of the observer. In the present embodiment, as illustrated in FIG. 1, from the perspective of the observer, the first display surface 102 and the second display surface 104 are positioned farther away than the display unit 20. Additionally, the first display surface 102 is positioned more to the observer side (the −Z side) than the second display surface 104.

The observer views the virtual image of the first image on the first display surface 102 and the virtual image of the second image on the second display surface 104 that are sequentially displayed in time divisions, and recognizes that the display target is positioned between the first display surface 102 and the second display surface 104. The position of the display target that the observer recognizes can be changed by adjusting brightness (for example, luminance) ratio of the first image to the second image. For example, when the luminance ratio of the first image to the second image is 1:1, the observer recognizes that the display target is positioned between the first display surface 102 and the second display surface 104.

In one example, the polarized bifocal lens 60 is implemented as a liquid crystal lens. As illustrated in FIG. 4, the polarized bifocal lens (the liquid crystal lens) 60 includes a first light-transmitting substrate 61, a second light-transmitting substrate 62, and a liquid crystal 64.

In one example, the first light-transmitting substrate 61 and the second light-transmitting substrate 62 are implemented as glass substrates. The first light-transmitting substrate 61 includes a resin fresnel lens 66 on a first main surface 61a that faces the second light-transmitting substrate 62. The first light-transmitting substrate 61 and the second light-transmitting substrate 62 are adhered to each other by a sealing material 67, thereby sandwiching the liquid crystal 64. In one example, the liquid crystal 64 is implemented as a nematic liquid crystal that has positive refractive index anisotropy (Δn=ne−no>0, where ne is a refractive index of extraordinary ray, and no is a refractive index of ordinary ray). The liquid crystal 64 is aligned in the Y direction by a non-illustrated alignment film.

When the display light PL2 of the first image of which the polarization direction is the X direction, enters the polarized bifocal lens 60, the nematic liquid crystal that has positive refractive index anisotropy is aligned in the Y direction and, as such, the focal length of the polarized bifocal lens 60 for the display light PL2 is long. Accordingly, the first image is formed on the first display surface 102. When the display light PL2 of the second image of which the polarization direction is the Y direction, enters the polarized bifocal lens 60, the focal length of the polarized bifocal lens 60 for the display light PL2 is short. Accordingly, the second image is formed on the second display surface 104.

### Controller

The controller 80 of the three-dimensional-image display device 10 generates, based on three-dimensional object data expressing the display target inputted from an external device, first image data expressing the first image, and second image data expressing the second image. The three-dimensional object data includes coordinate data expressing the position of the display target in a display space, color data expressing a color of the display target, and luminance data expressing luminance of the display target.

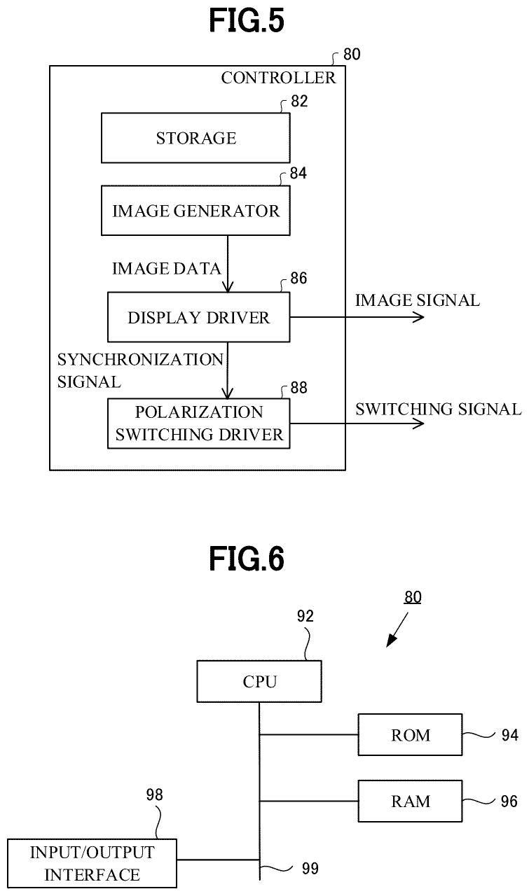

The controller 80 supplies, to the display unit 20, the first image signal for displaying the first image to the liquid crystal display panel 22 (the display unit 20), the second image signal for displaying the second image to the liquid crystal display panel 22 (the display unit 20), and the minimum luminance signal, thereby controlling display of the display unit 20. Additionally, the controller 80 supplies the switching signal to the polarization switcher 50, thereby controlling the polarization switcher 50. As illustrated in FIG. 5, the controller 80 includes a storage 82, an image generator 84, a display driver 86, and a polarization switching driver 88.

The storage 82 of the controller 80 stores programs that cause the image generator 84, the display driver 86, and the polarization switching driver 88 to function. Additionally, the storage 82 stores various types of data such as display surface data, perspective data, a distance between the observer and the first display surface 102, a distance between the observer and the second display surface 104, and the like. The display surface data is coordinate data expressing the positions of the first display surface 102 and the second display surface 104 in the display space (three-dimensional space) in which the display target is displayed. The perspective data is coordinate data expressing the position of the perspective of the observer in the display space.

The image generator 84 of the controller 80 calculates, based on the three-dimensional object data, the display surface data, and the perspective data, the luminance ratio of the luminance of the first image to the luminance of the second image. Then, the image generator 84 of the controller 80 generates the first image data expressing the first image, and the second image data expressing the second image. The image generator 84 outputs the first image data and the second image data to the storage 82 (frame memory) to store the data in the storage 82. Hereinafter, the first image data and the second image data may be collectively referred to as “image data”.

The display driver 86 of the controller 80 configures, with a plurality of frame periods FP, each of a first display period DP1 expressing the first image and a second display period DP2 expressing the second image. The display driver 86 controls the luminance of the pixels P of the liquid crystal display panel 22 to minimum luminance Lmin of the pixels P in a last frame period FP of the plurality of frame periods FP included in the first display period DP1. The display driver 86 controls the luminance of the pixels P of the liquid crystal display panel 22 to the minimum luminance Lmin of the pixels P in a last frame period FP of the plurality of frame periods FP included in the second display period DP2. The minimum luminance Lmin of the pixels P is calculated in advance, and is stored in the storage 82. Controlling the luminance of the pixels P of the liquid crystal display panel 22 to the minimum luminance Lmin of the pixels P is also expressed as setting a gradation of the pixels P of the liquid crystal display panel 22 to a zero gradation.

In the following, the first display period DP1 and the second display period DP2 may also be referred to collectively as “display periods”. The minimum luminance Lmin of the pixels P may also be referred to as “minimum luminance Lmin”.

The display driver 86 sequentially reads the first image data and the second image data from the storage 82, and generates the first image signal for displaying the first image and the second image signal for displaying the second image. Furthermore, the display driver 86 generates a minimum luminance signal for controlling, in the last frame period FP of the display period, the luminance of the pixels P of the liquid crystal display panel 22 to the minimum luminance Lmin.

The display driver 86 supplies the generated image signals and the generated minimum luminance signal to the liquid crystal display panel 22. Additionally, the display driver 86 supplies a synchronization signal synchronized with the display period to the polarization switching driver 88. The display control of the liquid crystal display panel 22 is described later.

The polarization switching driver 88 of the controller 80 generates a switching signal based on the synchronization signal supplied from the display driver 86. Additionally, the polarization switching driver 88 supplies the generated switching signal to the polarization switcher 50. In the present embodiment, when the first image is displayed on the liquid crystal display panel 22, the polarization switching driver 88 sets the switching signal to the ON level, and supplies the switching signal to the polarization switcher 50.

FIG. 6 illustrates a hardware configuration of the controller 80. The controller 80 includes a central processing unit (CPU) 92, a read-only memory (ROM) 94, a random access memory (RAM) 96, and an input/output interface 98. The CPU 92, the ROM 94, the RAM 96, and the input/output interface 98 are connected via a bus 99. The CPU 92 executes various types of processing. The ROM 94 stores programs and data. The RAM 96 stores data. The input/output interface 98 inputs and outputs signals between the CPU 92, and the display unit 20 (the liquid crystal display panel 22), the variable focus lens unit 40 (the polarization switcher 50), and external devices. The CPU 92 executes the programs stored in the ROM 94 to achieve the functions of the controller 80.

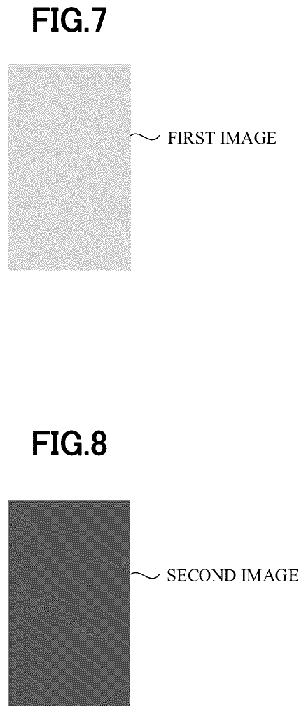

The display control of the liquid crystal display panel 22 is described. In the present embodiment, to facilitate comprehension, the first image is described as an image (a gray image closer to white) having the same high luminance throughout the entire image as illustrated in FIG. 7, and the second image is described as an image (a gray image closer to black) having the same low luminance throughout the entire image as illustrated in FIG. 8. Furthermore, the display driver 86 supplies a signal to the liquid crystal display panel 22 on a 240 Hz cycle (the frame period FP: 4.2 mS), and the liquid crystal display panel 22 performs the line progressive scanning (that is, the writing to the pixels P) on a 240 Hz cycle.

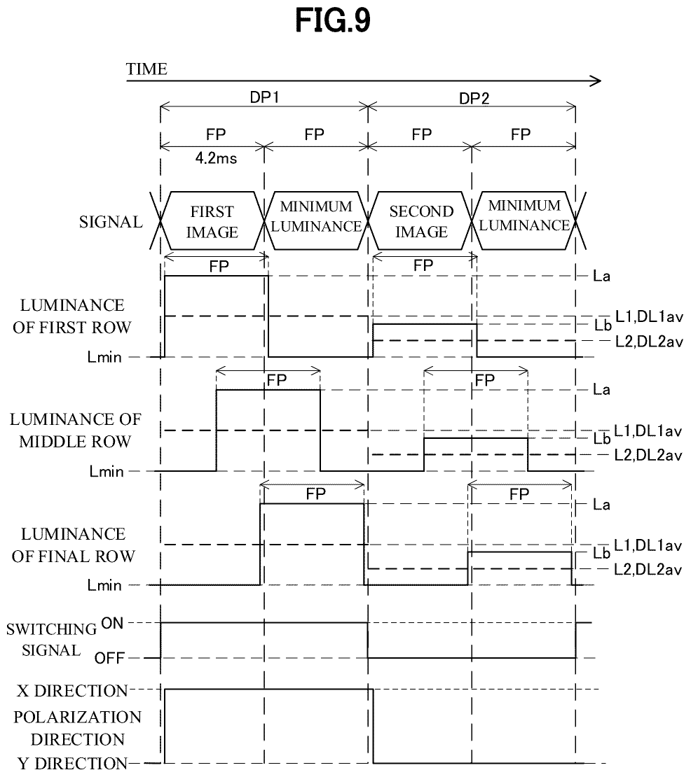

FIG. 9 is a diagram for explaining display control of the liquid crystal display panel 22 and control of the polarization switcher 50. In FIG. 9, the first tier illustrates signals (the first image signal, the second image signal, and the minimum luminance signal) that are supplied to the liquid crystal display panel 22 from the display driver 86 of the controller 80. The second tier of FIG. 9 illustrates luminance of the pixels P of the first row of the liquid crystal display panel 22 in the line progressive scanning. The third tier of FIG. 9 illustrates luminance of the pixels P of a middle row of the liquid crystal display panel 22 in the line progressive scanning. The fourth tier of FIG. 9 illustrates luminance of the pixels P of the final row of the liquid crystal display panel 22 in the line progressive scanning. The fifth tier of FIG. 9 illustrates the switching signal supplied to the polarization switcher 50 from the polarization switching driver 88 of the controller 80. The sixth tier of FIG. 9 illustrates the polarization direction of the display light PL2 emitted from the polarization switcher 50.

As illustrated in FIG. 9, the display driver 86 of the controller 80 configures each of the first display period DP1 expressing the first image and the second display period DP2 expressing the second image with two frame periods FP. As illustrated in the first tier of FIG. 9, the display driver 86 supplies the image signal (the first image signal or the second image signal) to the liquid crystal display panel 22 in the first frame period FP of the two frame periods FP. The display driver 86 supplies the minimum luminance signal to the liquid crystal display panel 22 in the last frame period FP (the second frame) of the two frame periods FP. Specifically, the display driver 86 sequentially supplies the first image signal, the minimum luminance signal, the second image signal, and the minimum luminance signal to the liquid crystal display panel 22 on a 240 Hz cycle (the frame period FP: 4.2 mS).

In the following, the luminance of the pixels P in the first image signal is referred to as La, and the luminance of the pixels P in the second image signal is referred to as Lb. The luminance La of the pixels P in the first image signal corresponds to luminance of the pixels P, of the liquid crystal display panel 22, displaying the first image, and also corresponds to predetermined luminance. The luminance Lb of the pixels P in the second image signal corresponds to luminance of the pixels P, of the liquid crystal display panel 22, displaying the second image, and also corresponds to the predetermined luminance.

In the first display period DP1 expressing the first image, average luminance of the pixels P of the liquid crystal display panel 22 is referred to as DL1av. In the second display period DP2 expressing the second image, average luminance of the pixels P of the liquid crystal display panel 22 is referred to as DL2av. The average luminance of the pixels P of the liquid crystal display panel 22 in the display period refers to luminance obtained by averaging the luminance of the pixels P of the liquid crystal display panel 22 over the display period. The average luminance DL1av and the average luminance DL2av may also be collectively referred to as average luminance.

The liquid crystal display panel 22 sequentially performs the line progressive scanning (writing to the pixels P) on a 240 Hz cycle in accordance with the signals sequentially supplied from the display driver 86. The liquid crystal display panel 22 sequentially displays the first image and the second image.

Specifically, as illustrated in the second tier of FIG. 9, the luminance of the pixels P of the first row of the liquid crystal display panel 22 in the line progressive scanning is the luminance La in the vicinity of the beginning of the first frame period FP of the first display period DP1, and is the minimum luminance Lmin in the vicinity of the beginning of the last frame period FP of the first display period DP1. Then, the luminance of the pixels P of the first row of the liquid crystal display panel 22 in the line progressive scanning is the luminance Lb in the vicinity of the beginning of the first frame period FP of the second display period DP2, and is the minimum luminance Lmin in the vicinity of the beginning of the last frame period FP of the second display period DP2.

Then, in the first display period DP1 including the two frame periods FP, the luminance of the pixels P of the first row of the liquid crystal display panel 22 in the line progressive scanning is the luminance La for a single frame period FP, and is the minimum luminance Lmin for the other single frame period FP. Furthermore, in the second display period DP2 including the two frame periods FP, the luminance of the pixels P of the first row of the liquid crystal display panel 22 in the line progressive scanning is the luminance Lb for a single frame period FP, and is the minimum luminance Lmin for the other single frame period FP. Accordingly, in the first row in the line progressive scanning, the average luminance DL1av of the pixels P of the liquid crystal display panel 22 in the first display period DP1 is expressed by DL1av=(La+Lmin)/2. The average luminance DL2av of the pixels P of the liquid crystal display panel 22 in the second display period DP2 is expressed by DL2av=(Lb+Lmin)/2.

As illustrated in the third tier of FIG. 9, the luminance of the pixels P of the middle row of the liquid crystal display panel 22 in the line progressive scanning is the luminance La in the vicinity of the center of the first frame period FP of the first display period DP1, and is the minimum luminance Lmin in the vicinity of the center of the last frame period FP of the first display period DP1. Then, the luminance of the pixels P of the middle row is the luminance Lb in the vicinity of the center of the first frame period FP of the second display period DP2, and is the minimum luminance Lmin in the vicinity of the center of the last frame period FP of the second display period DP2.

Similarly to the first row, even in the middle row of the liquid crystal display panel 22 in the line progressive scanning, the luminance of the pixels P of the liquid crystal display panel 22 in the first display period DP1 is the luminance La for a single frame period FP, and is the minimum luminance Lmin for the other single frame period FP. Additionally, the luminance of the pixels P of the middle rows of the liquid crystal display panel 22 in the second display period DP2 is the luminance Lb for a single frame period FP, and is the minimum luminance Lmin for the other single frame period FP. Therefore, the average luminance DL1av in the middle row is expressed by DL1av=(La+Lmin)/2. The average luminance DL2av is expressed by DL2av=(Lb+Lmin)/2.

As illustrated in the fourth tier of FIG. 9, the luminance of the pixels P of the final row of the liquid crystal display panel 22 in the line progressive scanning is the luminance La in the vicinity of the end of the first frame period FP of the first display period DP1, and is the minimum luminance Lmin in the vicinity of the end of the last frame period FP of the first display period DP1. Then, the luminance of the pixels P of the final row is the luminance Lb in the vicinity of the end of the first frame period FP of the second display period DP2, and is the minimum luminance Lmin in the vicinity of the end of the last frame period FP of the second display period DP2.

Even in the pixels P of the final row, the luminance of the pixels P of the liquid crystal display panel 22 in the first display period DP1 is the luminance La for a single frame period FP, and is the minimum luminance Lmin for the other single frame period FP. Additionally, the luminance of the pixels P of the final row of the liquid crystal display panel 22 in the second display period DP2 is the luminance Lb for a single frame period FP, and is the minimum luminance Lmin for the other single frame period FP. The average luminance DL1av in the final row is expressed by DL1av=(La+Lmin)/2. The average luminance DL2av is expressed by DL2av=(Lb+Lmin)/2.

As described above, in the present embodiment, the average luminance DL1av is expressed by DL1av=(La+Lmin)/2 and the average luminance DL2av is expressed by DL2av=(Lb+Lmin)/2, independent of the position of the liquid crystal display panel 22 in the line progressive direction. That is, the display periods (the first display period DP1 and the second display period DP2) each include a plurality of frame periods FP (two frame periods FP) and the luminance of the pixels P of the liquid crystal display panel 22 is controlled to the minimum luminance Lmin in the last frame period FP (the second frame) of the plurality of frame periods FP included in the display period. Therefore, the three-dimensional-image display device 10 can control the average luminance (the average luminance DL1av and the average luminance DL2av) of the pixels P of the liquid crystal display panel 22 over the display period, independent of the position of the liquid crystal display panel 22 in the line progressive direction.

In the present embodiment, when the luminance of the pixels P in the first image data is L1 and the luminance of the pixels P in the second image data is L2, the display driver 86 sets the luminance La of the pixels P in the first image signal and the luminance Lb of the pixels P in the second image signal to satisfy Formula (1) and Formula (2) below. The luminance La is the luminance of the pixels P, of the liquid crystal display panel 22, displaying the first image. The luminance Lb is the luminance of the pixels P, of the liquid crystal display panel 22, displaying the second image. Note that the luminance L1 of the pixels P in the first image data and the luminance L2 of the pixels P in the second image data are also expressed as luminance that the liquid crystal display panel 22 is to display or target luminance of the liquid crystal display panel 22.

$$L 1 = DL 1 av = \frac{La + L min}{2} \qquad ( 1 )$$

$$L 2 = DL 2 av = \frac{Lb + L min}{2} \qquad ( 2 )$$

That is, the display driver 86 sets the luminance of the pixels P by the pixel signal, that is, the luminance of the pixels P, of the liquid crystal display panel 22, displaying an image, to luminance that matches the luminance of the pixels P in the image data to the average luminance of the pixels P of the liquid crystal display panel 22 over the display period. Due to this configuration, the three-dimensional-image display device 10 enables the observer to recognize a correct first image and a correct second image.

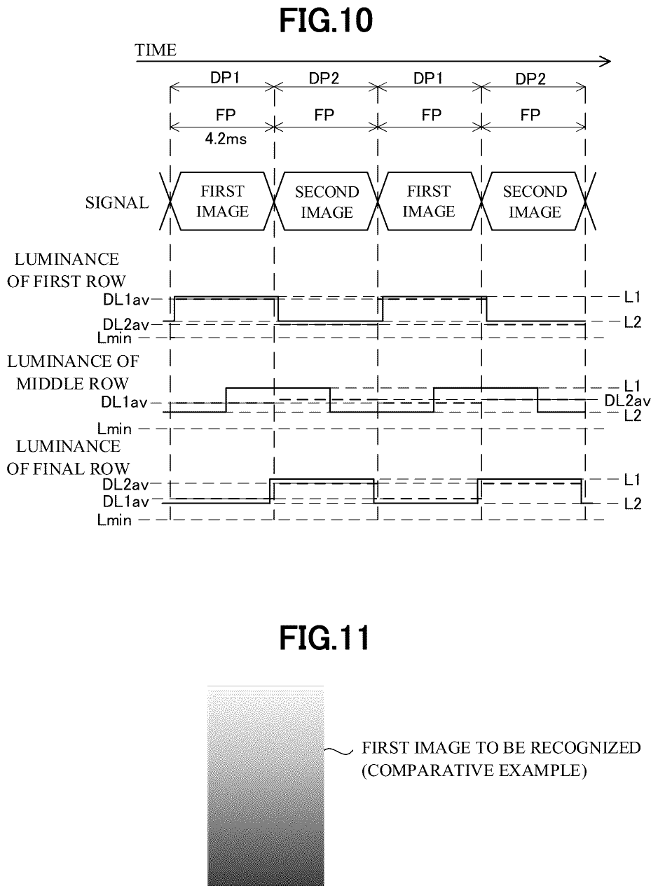

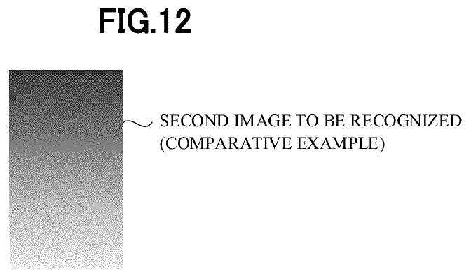

Meanwhile, in a case where the display driver 86 configures each of the first display period DP1 expressing the first image and the second display period DP2 expressing the second image with a single frame period FP, the average luminance (the average luminance DL1av and the average luminance DL2av) of the pixels P of the liquid crystal display panel 22 over the display period differs depending on the position of the liquid crystal display panel 22 in the line progressive direction, as illustrated in FIG. 10. Hereinafter, this example is referred to as a comparative example. This allows the observer to recognize the first image as an image illustrated in FIG. 11, and recognize the second image as an image illustrated in FIG. 12. As a result, in the comparative example, the first image and the second image are not displayed correctly, and the observer recognizes a three-dimensional image having a shape different from the shape of a three-dimensional image to be displayed.

With reference again to the fifth tier of FIG. 9, the polarization switching driver 88 of the controller 80 supplies the ON level switching signal to the polarization switcher 50 in synchronization with a supply of the first image signal by the display driver 86. Furthermore, the polarization switching driver 88 supplies the OFF level switching signal to the polarization switcher 50 in synchronization with a supply of the second image signal by the display driver 86. As illustrated in the sixth tier of FIG. 9, the polarization switcher 50 switches the polarization direction of the display light PL2 in accordance with the switching signal.

As described above, the display period includes a plurality of frame periods FP and the luminance of the pixels P of the liquid crystal display panel 22 is controlled to the minimum luminance Lmin of the pixels P in the last frame period FP of the plurality of frame periods FP included in the display period. Therefore, the three-dimensional-image display device 10 can control the average luminance of the pixels P of the liquid crystal display panel 22 over the display period, independent of the position of the liquid crystal display panel 22 in the line progressive direction. By setting the luminance of the pixels P by the pixel signal, that is, the luminance of the pixels P, of the liquid crystal display panel 22, displaying the image to luminance that matches the luminance of the pixels P in the image data to the average luminance of the pixels P of the liquid crystal display panel 22 over the display period, the three-dimensional-image display device 10 enables the observer to recognize a correct first image and a correct second image and correctly display a three-dimensional image.

### Embodiment 2

In Embodiment 1, the display period includes two frame periods FP, and the luminance of the pixels P of the liquid crystal display panel 22 is controlled to the minimum luminance Lmin in the last frame period FP of the two frame periods FP. It is sufficient that the display period includes a plurality of frame periods FP. The luminance of the pixels P of the liquid crystal display panel 22 may be controlled to the minimum luminance Lmin in a frame period FP other than the last frame period FP of the plurality of frame periods FP included in the display period.

As with the three-dimensional-image display device 10 of Embodiment 1, a three-dimensional-image display device 10 of the present embodiment includes a display unit 20, a variable focus lens unit 40, and a controller 80. With the exception of the configuration of a display driver 86 of the controller 80, the configuration of the three-dimensional-image display device 10 of the present embodiment is similar to the configuration of the three-dimensional-image display device 10 of Embodiment 1. As such, here, the configuration of the display driver 86 of the controller 80 and display control of a liquid crystal display panel 22 of the present embodiment are described.

As with the display driver 86 of Embodiment 1, the display driver 86 of the present embodiment configures a display period with a plurality of frame periods FP. Furthermore, the display driver 86 of the present embodiment controls the luminance of the pixels P of the liquid crystal display panel 22 to the minimum luminance Lmin of the pixels P in a last frame period FP of the plurality of frame periods FP included in the display period.

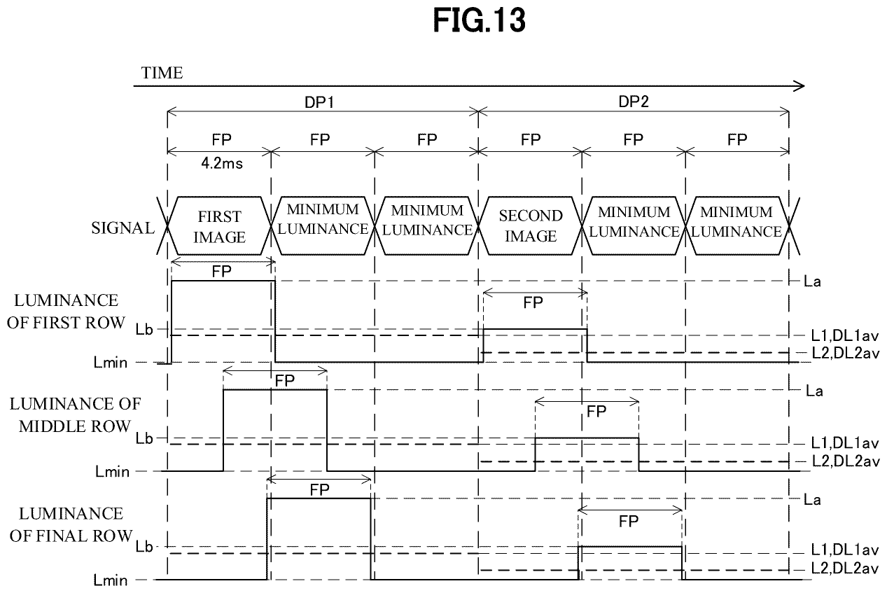

Specifically, as illustrated in FIG. 13, the display driver 86 of the present embodiment configures each of a first display period DP1 expressing a first image and a second display period DP2 expressing a second image with three frame periods FP. As illustrated in the first tier of FIG. 13, the display driver 86 of the present embodiment supplies an image signal (a first image signal or a second image signal) to the liquid crystal display panel 22 in a first frame period FP of the three frame periods FP. Furthermore, the display driver 86 of the present embodiment supplies a minimum luminance signal to the liquid crystal display panel 22 in a second frame period FP and a last frame period FP (the third frame) of the three frame periods FP.

The liquid crystal display panel 22 sequentially performs line progressive scanning (writing to the pixels P) in accordance with the signals sequentially supplied from the display driver 86. The liquid crystal display panel 22 sequentially displays the first image and the second image.

Specifically, as illustrated in the second tier of FIG. 13, in the first display period DP1 including the three frame periods FP, the luminance of the pixels P of the first row of the liquid crystal display panel 22 in the line progressive scanning is luminance La for a single frame period FP, and is the minimum luminance Lmin for the other two frame periods FP. Furthermore, in the second display period DP2 including the three frame periods FP, the luminance of the pixels P of the first row of the liquid crystal display panel 22 in the line progressive scanning is luminance Lb for a single frame period FP, and is the minimum luminance Lmin for the other two frame periods FP. Therefore, in the first row in the line progressive scanning, average luminance DL1av of the pixels P of the liquid crystal display panel 22 in the first display period DP1 is expressed by DL1av=(La+2×Lmin)/3, and average luminance DL2av of the pixels P of the liquid crystal display panel 22 in the second display period DP2 is expressed by DL2av=(Lb+2×Lmin)/3.

As illustrated in the second tier and the third tier of FIG. 13, in the first display period DP1, the luminance of the pixels P in the middle row and the final row of the liquid crystal display panel 22 is the luminance La for a single frame period FP, and is the minimum luminance Lmin for the other two frame periods FP. Additionally, in the second display period DP2, the luminance of the pixels P in the middle row and the final row of the liquid crystal display panel 22 is the luminance Lb for a single frame period FP, and is the minimum luminance Lmin for the other two frame periods FP. Accordingly, even in the middle rows and the final row in the line progressive scanning, the average luminance DL1av is expressed by DL1av=(La+2×Lmin)/3, and the average luminance DL2av is expressed by DL2av=(Lb+2×Lmin)/3.

As described above, in the present embodiment, the average luminance DL1av is expressed by DL1av=(La+2×Lmin)/3 and the average luminance DL2av is expressed by DL2av=(Lb+2×Lmin)/3, independent of the position of the liquid crystal display panel 22 in a line progressive direction. In the present embodiment as well, the display period is configured with a plurality of frame periods FP (three frame periods FP), and the luminance of the pixels P is controlled to the minimum luminance Lmin in a last frame period FP (the third frame) of the plurality of frame periods FP included in the display period. Therefore, the three-dimensional-image display device 10 can control the average luminance of the pixels P over the display period, independent of the position of the liquid crystal display panel 22 in the line progressive direction.

In the present embodiment as well, the display driver 86 sets the luminance of the pixels P by the pixel signal to luminance that matches the luminance of the pixels P in the image data to the average luminance of the pixels P of the liquid crystal display panel 22 over the display period. More specifically, the luminance La of the pixels P in the first image signal and the luminance Lb of the pixels P in the second image signal are set to satisfy Formula (3) and Formula (4) below. Due to this configuration, the three-dimensional-image display device 10 enables the observer to recognize a correct first image and a correct second image.

$$L 1 = DL 1 av = \frac{La + 2 \times L min}{3} \qquad ( 3 )$$

$$L 2 = DL 2 av = \frac{Lb + 2 \times L min}{3} \qquad ( 4 )$$

As described above, in the present embodiment as well, the three-dimensional-image display device 10 can control the average luminance of the pixels P of the liquid crystal display panel 22 over the display period, independent of the position of the liquid crystal display panel 22 in the line progressive direction. Additionally, the three-dimensional-image display device 10 according to the present embodiment enables the observer to recognize a correct first image and a correct second image and correctly display a three-dimensional image.

### Embodiment 3

In Embodiment 1 and Embodiment 2, the display driver 86 controls, in one frame period FP of the plurality of frame periods FP included in the first display period DP1, the luminance of the pixels P of the liquid crystal display panel 22 to luminance La, and controls, in one frame period FP of the plurality of frame periods FP included in the second display period DP2, the luminance of the pixels P of the liquid crystal display panel 22 to luminance Lb. The display driver 86 may control the luminance of the pixels P of the liquid crystal display panel 22 to the luminance La or the luminance Lb in a plurality of frame periods FP.

As with the three-dimensional-image display device 10 of Embodiment 1, a three-dimensional-image display device 10 of the present embodiment includes a display unit 20, a variable focus lens unit 40, and a controller 80. With the exception of the configuration of a display driver 86 of the controller 80, the configuration of the three-dimensional-image display device 10 of the present embodiment is similar to the configuration of the three-dimensional-image display device 10 of Embodiment 1. As such, here, the configuration of the display driver 86 of the controller 80 and display control of a liquid crystal display panel 22 of the present embodiment are described.

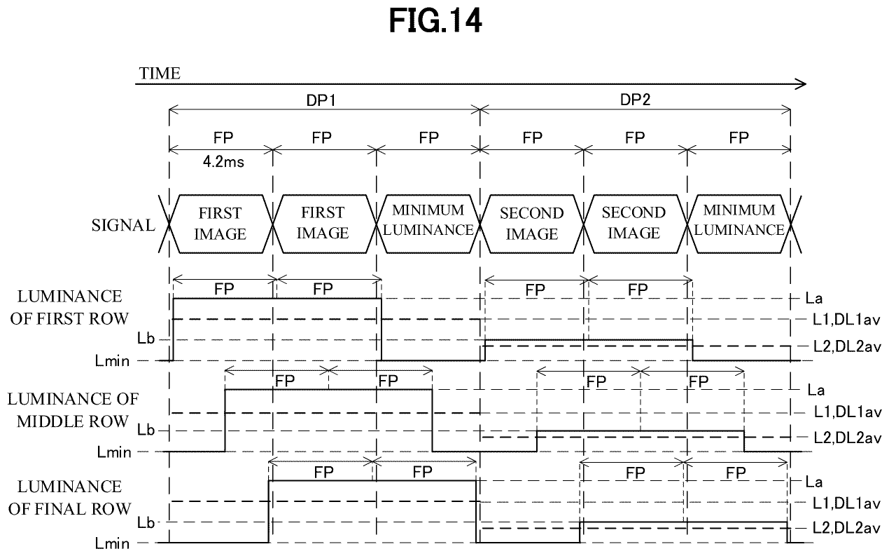

Specifically, as illustrated in FIG. 14, the display driver 86 of the present embodiment configures each of a first display period DP1 expressing a first image and a second display period DP2 expressing a second image with three frame periods FP. As illustrated in the first tier of FIG. 14, the display driver 86 of the present embodiment supplies an image signal (a first image signal or a second image signal) to the liquid crystal display panel 22 in a first frame period FP and a second frame period FP of the three frame periods FP. Furthermore, the display driver 86 of the present embodiment supplies a minimum luminance signal to the liquid crystal display panel 22 in a last frame period FP (the third frame) of the three frame periods FP.

The liquid crystal display panel 22 sequentially performs line progressive scanning (writing to the pixels P) in accordance with the signals sequentially supplied from the display driver 86. The liquid crystal display panel 22 sequentially displays the first image and the second image.

Specifically, as illustrated in the second tier of FIG. 14, in the first display period DP1 including the three frame periods FP, the luminance of the pixels P of the first row of the liquid crystal display panel 22 in the line progressive scanning is the luminance La for two frame periods FP, and is the minimum luminance Lmin for a single frame period FP. Furthermore, in the second display period DP2 including the three frame periods FP, the luminance of the pixels P of the first row of the liquid crystal display panel 22 in the line progressive scanning is the luminance Lb for two frame periods FP, and is the minimum luminance Lmin for a single frame period FP. Accordingly, in the first row in the line progressive scanning, average luminance DL1av of the pixels P of the liquid crystal display panel 22 in the first display period DP1 is expressed by DL1av=(2×La+Lmin)/3. Additionally, average luminance DL2av of the pixels P of the liquid crystal display panel 22 in the second display period DP2 is expressed by DL2av=(2×Lb+Lmin)/3.

As illustrated in the second tier and the third tier of FIG. 14, in the first display period DP1, the luminance of the pixels P in the middle row and the final row of the liquid crystal display panel 22 is the luminance La for two frame periods FP, and is the minimum luminance Lmin for a single frame period FP. Additionally, the luminance of the pixels P in the middle rows and the final row of the liquid crystal display panel 22 in the second display period DP2 is the luminance Lb for two frame periods FP, and is the minimum luminance Lmin for a single frame period FP. Accordingly, even in the middle rows and the final row in the line progressive scanning, the average luminance DL1av is expressed by DL1av=(La+2×Lmin)/3, and the average luminance DL2av is expressed by DL2av=(Lb+2×Lmin)/3.

As described above, the luminance of the pixels P is controlled to the minimum luminance Lmin in the last frame period FP of the plurality of frame periods FP included in the display period. Therefore, the three-dimensional-image display device 10 can control the average luminance of the pixels P over the display period, independent of the position of the liquid crystal display panel 22 in a line progressive direction.

In the present embodiment as well, the display driver 86 sets the luminance of the pixels P by the pixel signal to luminance that matches the luminance of the pixels P in the image data to the average luminance of the pixels P of the liquid crystal display panel 22 over the display period. More specifically, the luminance La of the pixels P in the first image signal and the luminance Lb of the pixels P in the second image signal are set to satisfy Formula (5) and Formula (6) below. Due to this configuration, the three-dimensional-image display device 10 enables the observer to recognize a correct first image and a correct second image.

$$L 1 = DL 1 av = \frac{2 \times La + L min}{3} \qquad ( 5 )$$

$$L 2 = DL 2 av = \frac{2 \times Lb + L min}{3} \qquad ( 6 )$$

Furthermore, in the present embodiment, the luminance of the pixels P of the liquid crystal display panel 22 is controlled to the luminance La or the luminance Lb in the plurality of frame periods FP. Therefore, in a case where the average luminance DL1av of Embodiments 1 and 2 in which the luminance of the pixels P of the liquid crystal display panel 22 is controlled to the luminance La in one frame period FP is the same as the average luminance DL1av of the present embodiment, the luminance (luminance La) of the pixels P of the liquid crystal display panel 22 according to the present embodiment can be smaller than the luminance (luminance La) of the pixels P of the liquid crystal display panel 22 according to Embodiments 1 and 2. Furthermore, in a case where the average luminance DL2av of Embodiments 1 and 2 is the same as the average luminance DL2av of the present embodiment, the luminance (luminance Lb) of the pixels P of the liquid crystal display panel 22 according to the present embodiment can be smaller than the luminance (luminance Lb) of the pixels P of the liquid crystal display panel 22 according to Embodiments 1 and 2.

As described above, in the present embodiment as well, the three-dimensional-image display device 10 can control the average luminance of the pixels P of the liquid crystal display panel 22 over the display period, independent of the position of the liquid crystal display panel 22 in the line progressive direction. Additionally, the three-dimensional-image display device 10 according to the present embodiment enables the observer to recognize a correct first image and a correct second image and correctly display a three-dimensional image.

### Embodiment 4

In Embodiments 1-3, the display unit 20 of the three-dimensional-image display device 10 includes the liquid crystal display panel 22 and the light source 32. However, the configuration of the display unit 20 is not limited thereto.

As with the three-dimensional-image display device 10 of Embodiment 1, a three-dimensional-image display device 10 of the present embodiment includes a display unit 20, a variable focus lens unit 40, and a controller 80. With the exception of the configuration of the display unit 20, the configuration of the three-dimensional-image display device 10 of the present embodiment is similar to the configuration of the three-dimensional-image display device 10 according to Embodiments 1-3.

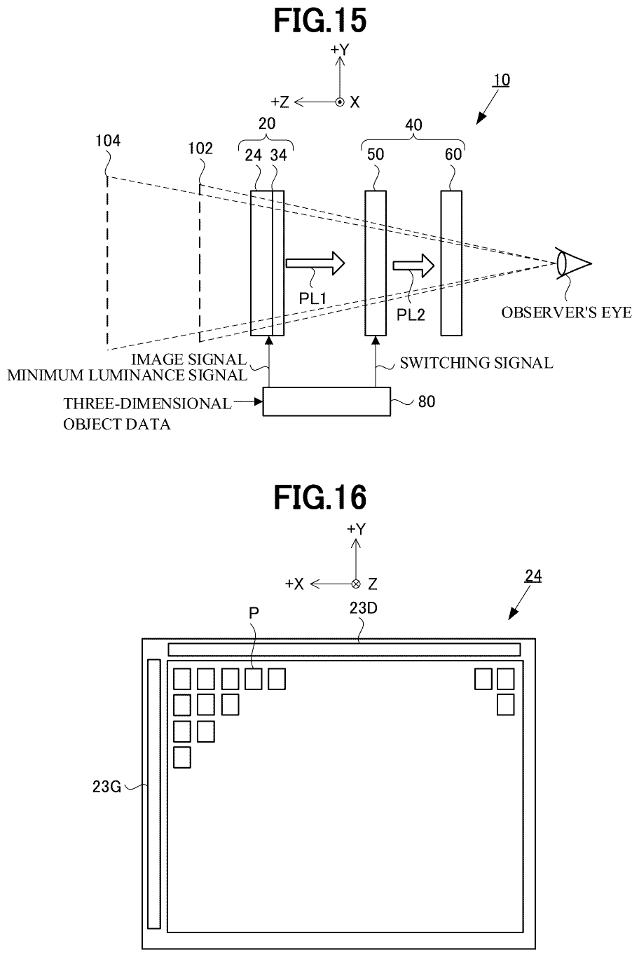

The display unit 20 according to the present embodiment includes a self-luminous display panel 24 and a polarizing plate 34, as illustrated in FIG. 15. The self-luminous display panel 24 is implemented as an organic electro luminescence (EL) display panel that is active matrix driven by line progressive scanning by TFTs. The polarizing plate 34 emits light from the self-luminous display panel 24 as display light PL1. The polarization direction of the display light PL1 is a predetermined first direction.

As illustrated in FIG. 16, the self-luminous display panel 24 includes pixels P arranged in a matrix, a gate driver 23G, and a data driver 23D. The configuration of the gate driver 23G and the data driver 23D of the present embodiment is similar to the configuration of the gate driver 23G and the data driver 23D according to Embodiments 1-3. The self-luminous display panel 24 includes a light-transmitting substrate, a self-luminous element (organic EL element), TFT, and the like, which are not illustrated.

As with the liquid crystal display panel 22 of Embodiments 1-3, display of the self-luminous display panel 24 is controlled. As with the three-dimensional-image display device 10 of Embodiments 1-3, the three-dimensional-image display device 10 of the present embodiment can control average luminance of the pixels P of the self-luminous display panel 24 over the display period, independent of the position of the self-luminous display panel 24 in a line progressive direction. Additionally, the three-dimensional-image display device 10 according to the present embodiment enables the observer to recognize a correct first image and a correct second image and correctly display a three-dimensional image.

As with Embodiment 3, in display control of the self-luminous display panel 24, in a case where a display driver 86 controls luminance of the pixels P of the self-luminous display panel 24 to luminance La or luminance Lb in a plurality of frame periods FP, the luminance La and the luminance Lb can be reduced, thereby extending the time until the luminance of the self-luminous display panel 24 is halved (luminance half-life Th). This effect is explained below using the organic EL display panel (organic EL element) as an example.

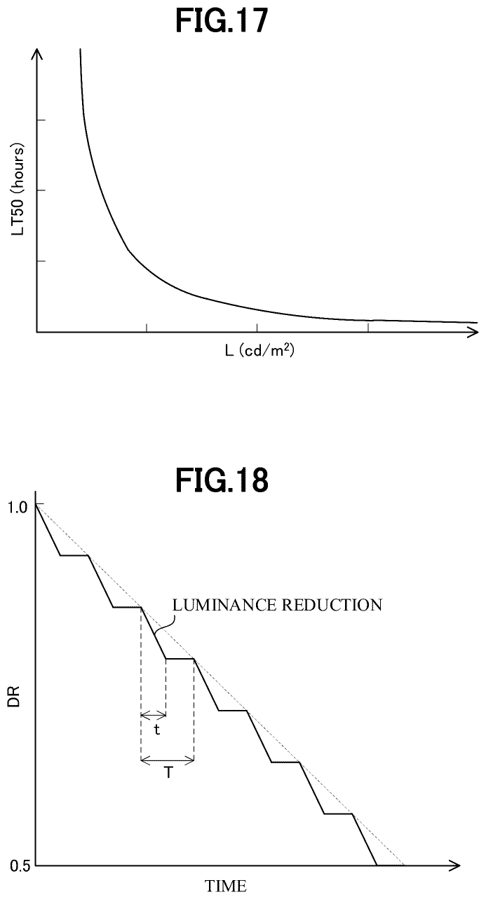

A relationship between a current density J (mA/cm²) of the organic EL element and a luminance half-life LT50 (hours) is known to be expressed by Formula (7) below. In a case where the organic EL element is made to continuously emit light, the current density J of the organic EL element and luminance L (cd/m²) is known to have a proportional relationship. Therefore, the luminance half-life LT50 and the luminance L of the organic EL element is expressed by Formula (8) below and illustrated as FIG. 17. N and b in Formula (7) vary depending on the configuration, materials, and the like of the organic EL element. Commonly, N is approximately 1.3 to 1.5, and b is approximately 5. Furthermore, A in Formula (8) is a proportionality constant.

$$Log ( LT 50 ) = - N \times Log ( J ) + b \qquad ( 7 )$$

$$Log ( LT 50 ) = - N \times Log ( A \times L ) + b \qquad ( 8 )$$

In a case where a rate at which the luminance of the organic EL element decreases with an emission time of the organic EL element where initial luminance of the organic EL element is 1 is defined as a luminance reduction rate DR, a length of the display period in the embodiments is defined as T, and a time during which the organic EL element emits light in the display period in the embodiments is defined as t, and when a change in the luminance reduction rate DR is linearly approximated based on Formula (8), the luminance reduction rate DR can be expressed as illustrated in FIG. 18. In FIG. 18, the time at which the luminance reduction rate DR is 0.5 corresponds to the luminance half-life Th of the self-luminous display panel 24 (organic EL display panel) of the embodiments.

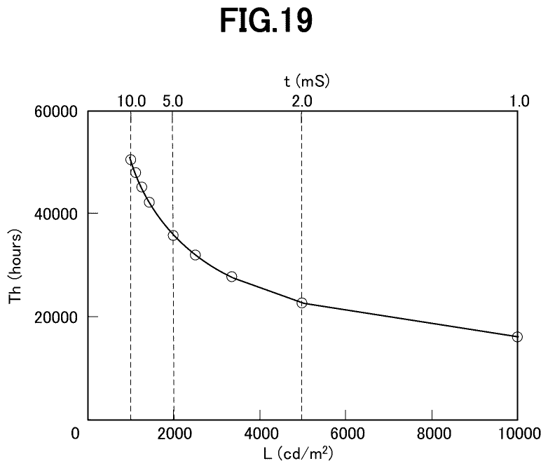

Furthermore, in a case where average luminance (L×t/T) of the pixels P over the display period is 1000 cd/cm² and the length T of the display period is 10 mS, an example of the relationship between (i) the luminance L of the organic EL element and the time t during which the organic EL element emits light, and (ii) the luminance half-life Th of the self-luminous display panel 24 is expressed as illustrated in FIG. 19. As illustrated in FIG. 19, the luminance half-life Th can be extended by lengthening the time t during which the organic EL element emits light and decreasing the luminance L of the organic EL element. That is, as with the display control of Embodiment 3, the luminance half-life Th (lifetime) of the self-luminous display panel 24 can be extended by controlling the luminance of the pixels P of the self-luminous display panel 24 to the luminance La or the luminance Lb in a plurality of frame periods FP and reducing the luminance La and Lb.

### Modified Examples

Although embodiments are described above, the embodiments can be modified in various manner without departing from the gist of the present disclosure.

In Embodiment 1, the light source 32 of the display unit 20 is implemented as a direct backlight, but the light source 32 is not limited to the direct backlight. For example, the light source 32 of the display unit 20 may be implemented as a side-edge backlight.

The polarization switcher 50 is not limited to the TN liquid crystal element. The polarization switcher 50 may be implemented as a lead lanthanum zirconate titanate (PLZT) element, an element that uses the Faraday effect, or the like.

Furthermore, the variable focus lens unit 40 may not necessary include a polarization switcher 50 and a polarized bifocal lens 60. A configuration is possible in which the variable focus lens unit 40 is implemented as a liquid lens in which the focal length changes based on voltage that is applied. For example, it is possible to use a liquid lens that uses electrowetting as the liquid lens.

In the embodiments, an example of a three-dimensional-image display device 10 using a monochrome display panel (a liquid crystal display panel 22 and a self-luminous display panel 24) is described, but a configuration is possible in which a color display panel is to be used instead of the monochrome display panel. In such a case, the pixels P can be configured as subpixels that are color-divided into red (R), green (G), blue (B), or the like.

When using the three-dimensional-image display device 10 in a head-mounted display, a configuration is possible in which the three-dimensional-image display device 10 includes a right-eye variable focus lens unit 40 and a left-eye variable focus lens unit 40. Additionally, a configuration is possible in which the head-mounted display includes a right-eye three-dimensional-image display device 10 and a left-eye three-dimensional-image display device 10.

In the embodiments, the controller 80 generates the first image data and the second image data from three-dimensional object data inputted from an external device. A configuration is possible in which the controller 80 receives the first image data and the second image data from an external device. In such a case, the controller 80 need not include an image generator 84.

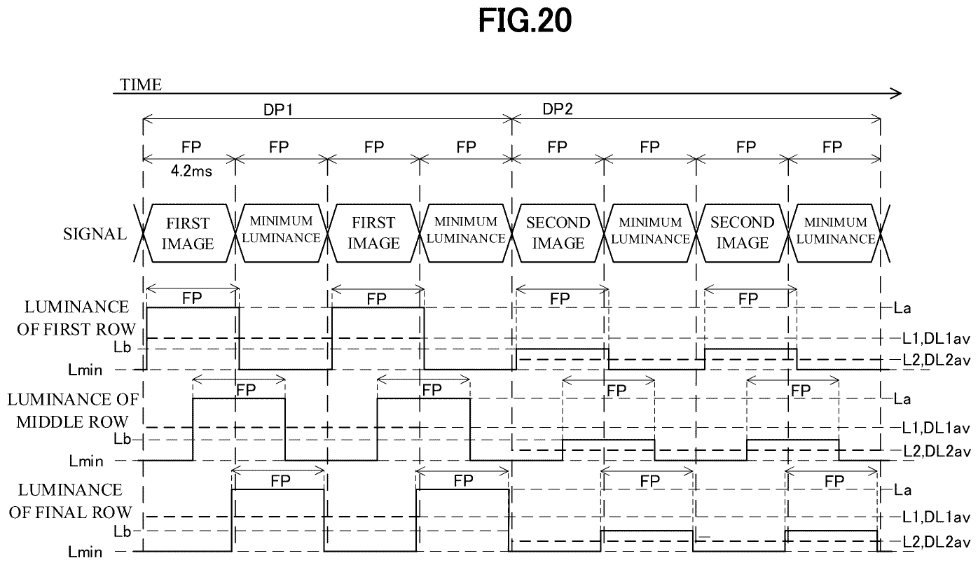

In Embodiment 2, the display driver 86 controls the luminance of the pixels P to the minimum luminance Lmin in two consecutive frame periods FP. In Embodiment 3, the display driver 86 controls the luminance of the pixels P to the luminance La or the luminance Lb in two consecutive frame periods FP. It is sufficient that the display driver 86 controls, in the last frame period FP of the plurality of frame periods FP included in the display period, the luminance of the pixels P to the minimum luminance Lmin, and controls, in at least one frame period FP of the plurality of frame periods FP, the luminance of the pixels P to the luminance La or the luminance Lb. For example, as illustrated in FIG. 20, the display driver 86 may control, in four frame periods FP included in the first display period DP1, the luminance of the pixels P to the luminance La, the minimum luminance Lmin, the luminance La, and the minimum luminance Lmin in an order thereof. The display driver 86 may control, in four frame periods FP included in the second display period DP2, the luminance of the pixels P to the luminance Lb, the minimum luminance Lmin, the luminance Lb, and the minimum luminance Lmin in an order thereof.

In a case where the number of frame periods FP included in the display period is M (where M is a natural number) and the number of frames in which the luminance of the pixels P is controlled to the luminance La or the luminance Lb is K (where K is a natural number), it is sufficient that the display driver 86 sets the luminance La and the luminance Lb to satisfy Formula (9) and Formula (10) below.

$$L 1 = DL 1 av = \frac{K \times La + ( M - K ) \times L min}{M} \qquad ( 9 )$$

$$L 2 = DL 2 av = \frac{K \times Lb + ( M - K ) \times L min}{M} \qquad ( 10 )$$

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

What is claimed is:

1. A three-dimensional-image display device, comprising:
a liquid crystal display panel to sequentially display a first image and a second image, and emit display light of the first image and display light of the second image;
a variable focus lens unit to switch between a focal length for the display light of the first image and a focal length for the display light of the second image; and
a controller to control display of the liquid crystal display panel, wherein
the first image and the second image are two-dimensional images and are obtained by projecting a display target from an observer side on a corresponding one of a first display surface and a second display surface, the first display surface and the second display surface being positioned at different positions in a depth direction from a perspective of an observer,
the liquid crystal display panel displays each of the first image and the second image by line progressive scanning,
the variable focus lens unit forms, as virtual images, the first image and the second image respectively on the first display surface and the second display surface, and
the controller
configures display periods, during which either the first image or the second image is displayed in each display period, each with a plurality of frame periods, and
controls luminance of pixels of the liquid crystal display panel to minimum luminance in a last frame period of the plurality of frame periods included in the display period.

2. A three-dimensional-image display device, comprising:
a self-luminous display panel to sequentially display a first image and a second image, and emit display light of the first image and display light of the second image;
a variable focus lens unit to switch between a focal length for the display light of the first image and a focal length for the display light of the second image; and
a controller to control display of the self-luminous display panel, wherein
the first image and the second image are two-dimensional images and are obtained by projecting a display target from an observer side on a corresponding one of a first display surface and a second display surface, the first display surface and the second display surface being positioned at different positions in a depth direction from a perspective of an observer,
the self-luminous display panel displays each of the first image and the second image by line progressive scanning,
the variable focus lens unit forms, as virtual images, the first image and the second image respectively on the first display surface and the second display surface, and
the controller
configures display periods, during which either the first image or the second image is displayed in each display period, each with a plurality of frame periods, and
controls luminance of pixels of the self-luminous display panel to minimum luminance in a last frame period of the plurality of frame periods included in the display period.

3. The three-dimensional-image display device according to claim 1, wherein
the controller matches the luminance of the pixels in pixel data expressing each of the first image and the second image to average luminance of the pixels over the display period.

4. The three-dimensional-image display device according to claim 2, wherein
the controller matches the luminance of the pixels in pixel data expressing each of the first image and the second image to average luminance of the pixels over the display period.

5. The three-dimensional-image display device according to claim 1, wherein
the controller controls the luminance of the pixels to the minimum luminance in the plurality of frame periods.

6. The three-dimensional-image display device according to claim 2, wherein
the controller controls the luminance of the pixels to the minimum luminance in the plurality of frame periods.

7. The three-dimensional-image display device according to claim 1, wherein
the controller controls the luminance of the pixels to predetermined luminance in the plurality of frame periods.

8. The three-dimensional-image display device according to claim 2, wherein
the controller controls the luminance of the pixels to predetermined luminance in the plurality of frame periods.
